(19) United States
(12) Patent Application Publication
(10) Pub. No.: US 2004/0067065 A1
(43) Pub. Date: Apr. 8, 2004

(54) Optical transmitter using nonlinear material and method

(75) Inventor: Katsumi Uesaka, Atherton, CA (US)

Correspondence Address: MCDERMOTT, WILL & EMERY, 18191 VON KARMAN AVE., SUITE 500, IRVINE, CA, 92612-7108, US

(73) Assignee: Innovation Core SEI, Inc.

(21) Appl. No.: 10/299,722

(22) Filed: Nov. 20, 2002

Related U.S. Application Data
(60) Provisional application No. 60/415,429, filed on Oct. 3, 2002.

(51) Int. Cl. H04B 10/00; H04B 10/04

(52) U.S. Cl. 398/194; 398/200

(57) ABSTRACT

An optical transmitter for compensating signal distortion, the optical transmitter includes an input for accepting a signal, a laser driver for amplifying and/or reshaping the signal, a distributed feedback laser diode coupled to the laser driver for signal modulation, a nonlinear material coupled to the distributed feedback laser diode for compensating signal distortions caused by the laser diode, and an output for sending the signal to the transmission link.

### RELATED APPLICATIONS

This application claims priority of Provisional Patent Application No. 60/415,429, filed Oct. 3, 2002.

### INCORPORATION BY REFERENCE

This application hereby incorporates by reference in its entirety an application filed with the United States Patent Office on Sep. 23, 2002, U.S. patent application Ser. No. 10/251,836 entitled An Optical Transmitter Using Highly Nonlinear Fiber and Method invented by Katsumi Uesaka.

### FIELD OF THE INVENTION

The field of the present invention relates generally to optical fiber (lightwave) communication systems. More particularly, the invention relates to a direct modulation optical transmitter using a nonlinear material (such as a film, a bulk structure or a waveguide) for signal distortion compensation.

### BACKGROUND INFORMATION

There is a growing interest in high speed optical data transmission, particularly for data rates greater than 10 Gbps. To accommodate this high speed data transmission, cost effective means of lightwave modulation have been explored. One such method is the addition of an external modulator to the optical transmitter. However, external modulators add expense, complexity and/or volume to the communication system and require additional amplifiers in the transmission line to compensate for the limited output power of the optical transmitter. Hence, an attractive alternative to external modulation is to incorporate direct modulation in a high power optical transmitter. One such direct modulation technique is to incorporate a directly modulated laser diode system (such as a distributed feedback laser diode “DFB-LD”) within the optical transmitter as shown in FIG. 1.

The advantages of the directly modulated laser diode system include its small size, low cost, low driving voltage and high output power characteristics. With direct modulation of a laser diode, an amplification-free design is achievable for long transmission distances. However, the disadvantage of this conventional system is the frequency chirp characteristic of the directly modulated laser diode system which distorts the signal and significantly limits the maximum achievable transmission distance. As shown in the example given in FIG. 1, a conventional optical transmitter may include a laser driver 2 to amplify and/or reshape the input signal 6 and a distributed feedback laser diode 3 for modulation. The signal 6 is transmitted through a single mode fiber 4 and received by an optical receiver 5. The conventional system would suffer from the disadvantage noted above.

One way to analyze data transmission systems is through a generated display called an eye pattern. An eye pattern may be created by applying the received signal to the vertical deflection plates of an oscilloscope. Additionally, a periodic sawtooth wave is applied to the horizontal deflection plates. The waveforms are then translated into a one interval display on the oscilloscope, resulting in an eye pattern similar to the one illustrated in FIG. 2. An eye pattern may also be synthesized via computer simulation. The interior region of the eye pattern is called the eye opening. The larger the width of the eye opening, the greater the time interval over which the received wave can be sampled without error from intersymbol interference. Additionally, the slope of the eye opening defines the sensitivity of the system to timing error while the height of the eye opening defines the margin over noise. See “Communication Systems”, Simon Haykin, Second Edition, pp. 496-497.

In this regard, FIG. 2 illustrates 10 Gbps output waveform signal quality after 40 km fiber transmission for the conventional optical receiver 5 by means of its simulated eye pattern discussed above. It is clear from FIG. 2 that the low eye opening height and timing jitter spreading in the eye pattern indicates that poor bit error rate performance will occur over this distance and at this data rate. Thus, the conventional solution of the directly modulated laser diode optical transmitter has created a problem of degradation of signal quality over long distance and high speed transmission.

Conventional solutions to this problem have taken three approaches. First, a dispersion compensation fiber (DCF) (including negative dispersion fiber) can be added to the transmission line to compensate the signal distortion. However, to be an effective solution, the length of the DCF needs to be matched to the length of the conventional fibers already installed. Thus, customizing the length of the DCF for each existing fiber system is required. An alternative is to reinstall all new fibers in the transmission path with negative dispersion fiber. Either alternative is expensive. Second, installing a narrow optical bandpass filter at the output of the distributed feedback laser (DFB-LD) will suppress the frequency chirping of the DFB-LD. But, the narrow bandwidth requirement needed by the bandpass filter increases the sensitivity to temperature variations and causes passband stability problems. Additionally, a narrow bandwidth limits the quantity of data transmission which is not desirable. Third, regenerators may be added to the transmission path to overcome the dispersion penalty. However, this solution greatly increases cost, complexity and/or volume to the transmission system.

FIGS. 3-8 refer to the characteristics and performance of an optical transmitter using highly nonlinear fiber as discussed in U.S. patent application Ser. No. 10/251,836, the subject matter of which has been incorporated herein by reference. In this previously filed application, a highly nonlinear fiber is used within the optical transmitter to compensate for frequency chirping.

FIG. 3 is a simulated eye pattern which illustrates 10 Gbps output waveform signal quality after 40 km fiber transmission measured at an optical receiver. The transmission system utilizes a highly nonlinear fiber within the optical transmitter for frequency chirp compensation. In contrast to FIG. 2, the eye pattern shown in FIG. 3 is much clearer, indicative of less signal distortion measured at the optical receiver. FIGS. 4-8 are characteristics and performance graphs of the same optical transmission system which uses a highly nonlinear fiber for frequency chirp compensation. FIG. 4 is a power profile versus time graph of a distributed feedback laser diode output waveform simulated at a bit rate of 10 Gbps. FIG. 5 is a frequency chirp profile versus time graph. The upper graph displays the chirping characteristics versus time at the output of a distributed feedback laser diode. The lower graph displays the chirping characteristics versus time after compensation is introduced by the highly nonlinear fiber. Comparison of the upper and lower graphs indicates that a nonlinear material (a highly nonlinear fiber in the present case) effectively reduces the frequency chirp to minimize transmitter signal distortion. Similarly, FIG. 6 illustrates the bit error rate (BER) performance and FIG. 7 illustrates the power penalty [dB] characteristics at a BER=10⁻⁹ of different transmission scenarios that utilize the self phase modulation of a nonlinear material (a highly nonlinear fiber in the present case). The graphs of FIGS. 6 and 7 illustrate the improved communication performance after application of the pre-chirping technique using a nonlinear material in the transmitter. FIG. 8 illustrates that the performance characteristics of a transmission link with a nonlinear material (a highly nonlinear fiber in the present case) is not sensitive to pseudo random bit sequence lengths.

While the invention disclosed therein produces a good quality signal at low cost, more than 10 km of highly nonlinear fiber must be used for an appropriate laser output power (˜10 mW). Therefore, it would be desirable to have a less complex, direct modulation optical transmitter system that uses a nonlinear material (such as a nonlinear film, bulk structure or waveguide) to compensate transmitter frequency chirping.

### SUMMARY OF THE INVENTION

The present invention addresses the drawbacks of the conventional optical signal transmission systems by providing a direct modulation optical transmitter system using a nonlinear material (implemented as, but not limited to, a film, a bulk structure or a waveguide) to compensate for transmitter frequency chirping. The present invention overcomes the signal distortion problem with the use of a nonlinear material to reduce effective length at a selected nonlinear index coefficient.

According to one aspect of the invention, the optical transmitter of the present invention includes an input for inputting a signal, a laser diode for signal modulation, a nonlinear material coupled to the laser diode for compensating signal distortions caused by the laser diode and an output for outputting the signal. In a preferred embodiment, the nonlinear material is a film, a bulk structure or a waveguide.

In another aspect of the invention, the present invention is an optical transmitter which includes a laser unit for signal amplification and/or signal modulation and a nonlinear material for compensating signal distortions. In a preferred embodiment, the optical transmitter further includes at least one optical lens for focusing an input signal, and an isolator for compensating signal reflection.

In yet another aspect of the invention, the present invention is an optical transmission system which includes an optical transmitter with an input for inputting a signal, a laser unit for amplifying the signal, and an output for outputting the signal; and a single mode fiber coupled to the optical transmitter output with the single mode fiber including a nonlinear material portion for compensating transmitter signal distortions.

In yet another aspect of the invention, the present invention is a method for transmitting a signal by generating a signal, modulating the signal with a modulator and compensating distortion to the signal by passing the signal through a nonlinear material.

### BRIEF DESCRIPTION OF THE DRAWINGS

FIG. 1 is a block diagram of a conventional direct modulation optical transmission system.

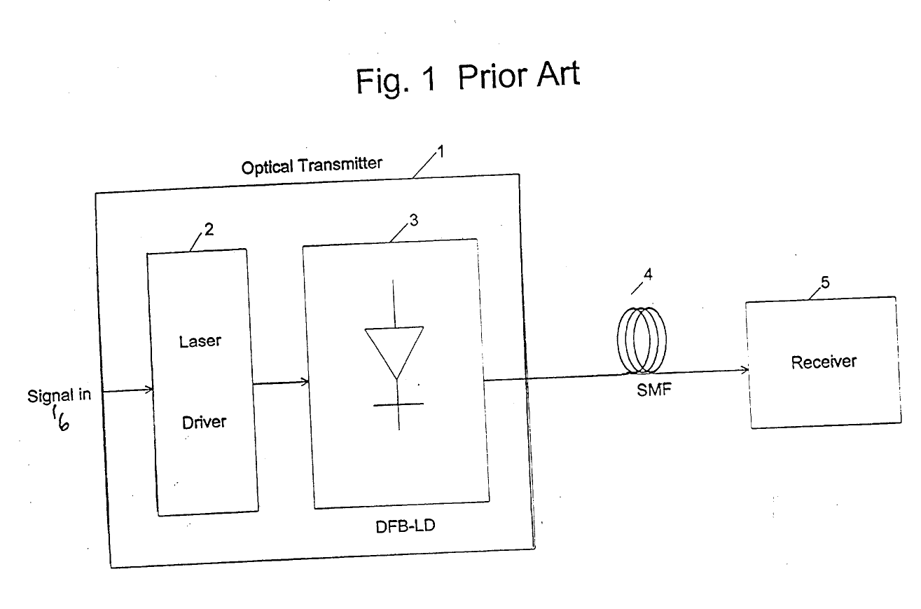

FIG. 2 illustrates the simulated 10 Gbps receiver output waveform eye pattern after 40 km fiber transmission using the conventional optical transmission system.

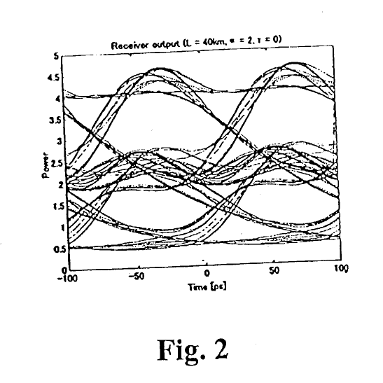

FIG. 3 illustrates the simulated 10 Gbps receiver output waveform eye pattern after 40 km fiber transmission using an optical transmission system with a highly nonlinear fiber at its output.

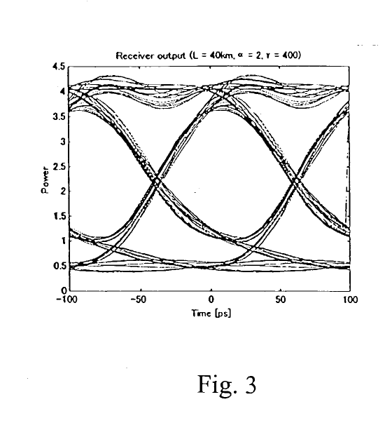

FIG. 4 is a power profile versus time graph of a laser diode output waveform simulation.

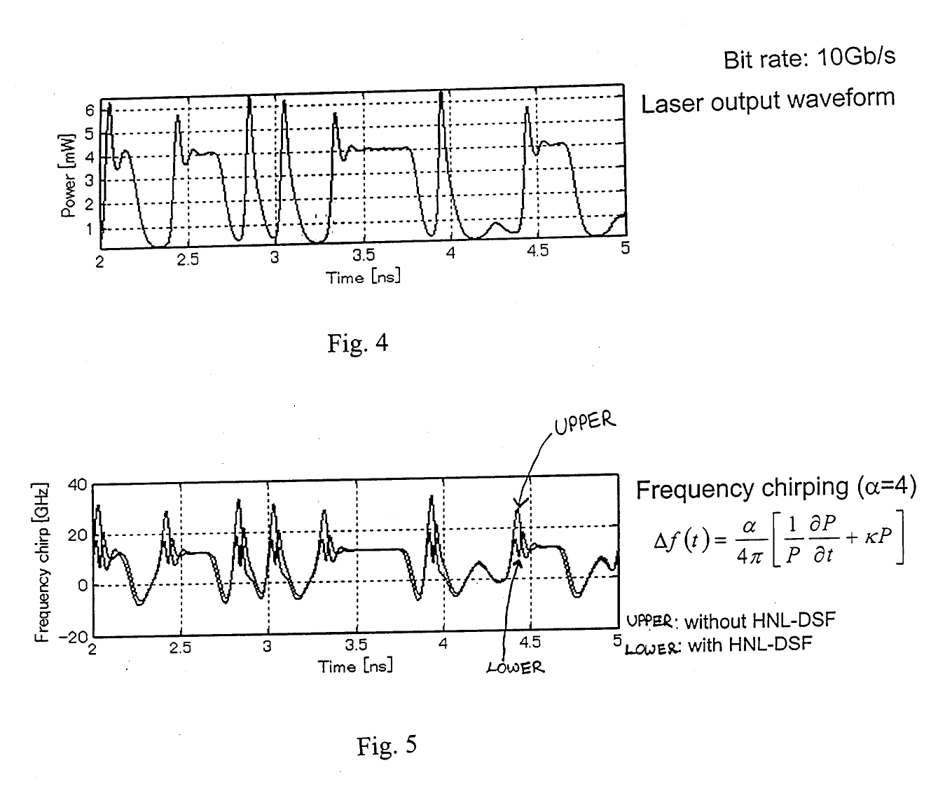

FIG. 5 is a frequency chirp profile versus time graph of a laser diode output waveform simulation comparing the effects of no chirping compensation versus with chirping compensation as introduced by a highly nonlinear dispersion shifted fiber.

FIG. 6 illustrates the bit error rate (BER) characteristics for three transmission scenarios utilizing the self phase modulation of a highly nonlinear dispersion shifted fiber.

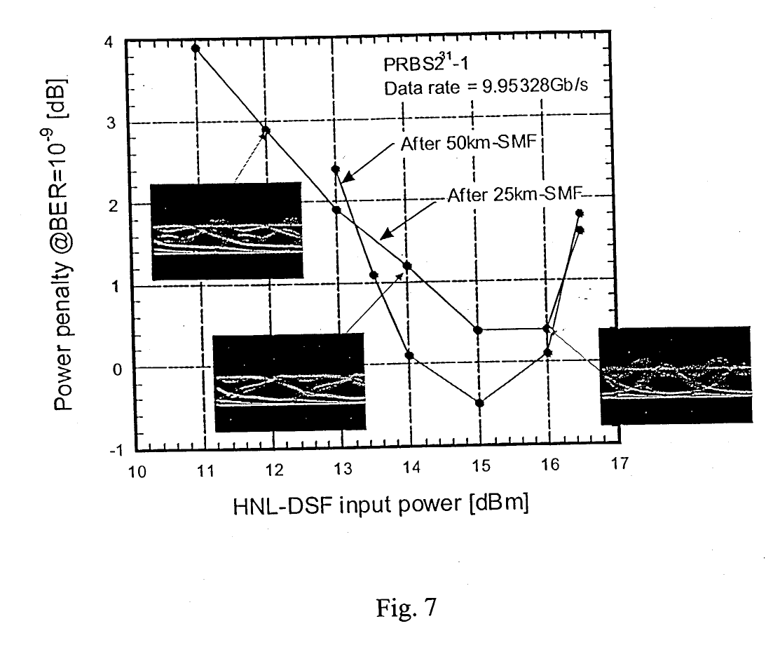

FIG. 7 illustrates the power penalty characteristics of a highly nonlinear dispersion shifted fiber for two single mode fiber lengths at a bit error rate (BER) of 10⁻⁹.

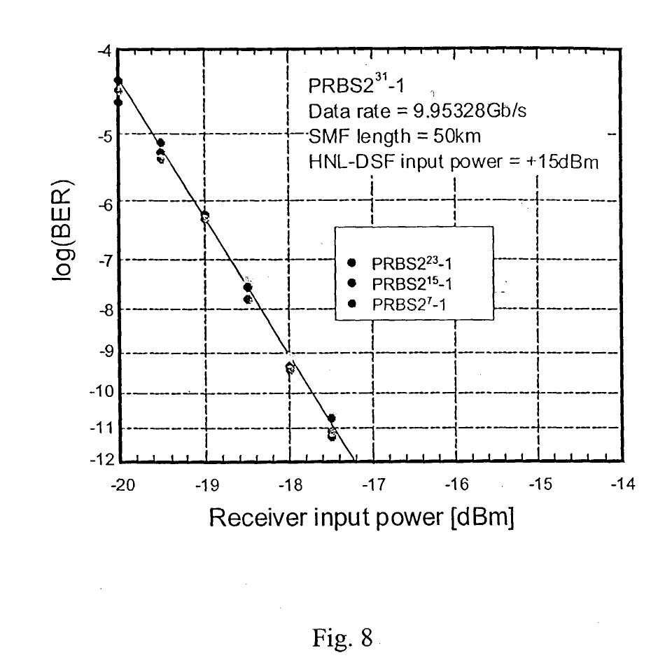

FIG. 8 illustrates the bit error rate (BER) characteristics for various pseudo random bit sequence (PRBS) lengths using highly nonlinear dispersion shifted fiber.

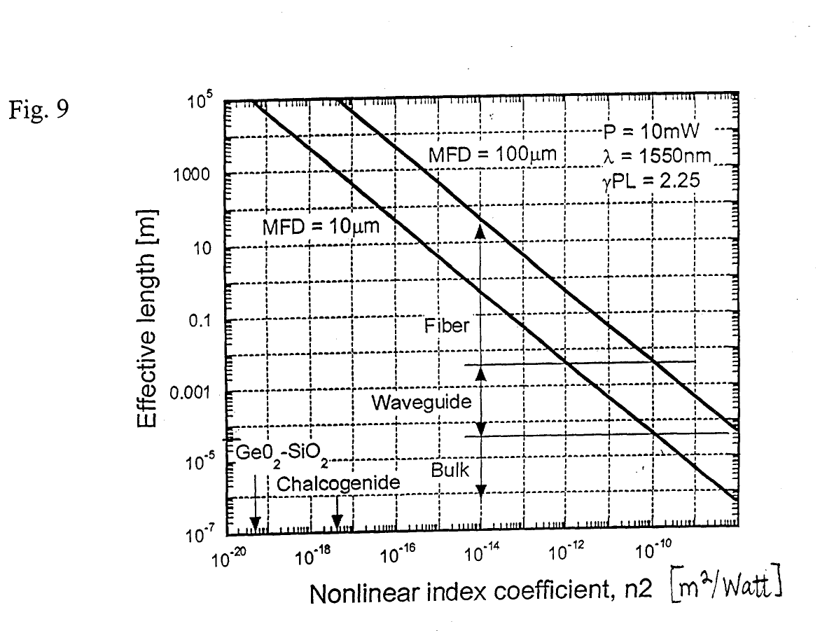

FIG. 9 is a logarithmic plot of an effective length profile versus nonlinear index coefficient graph.

FIG. 10 is a block diagram of a first embodiment of an optical transmission system in accordance with the present invention.

FIG. 11 is a frequency chirp profile versus time graph simulation comparing the effects of no chirping compensation versus with chirping compensation as introduced by a nonlinear material.

FIG. 12 illustrates the power penalty characteristics of a nonlinear material for two single mode fiber lengths at a bit error rate (BER) of 10⁻⁹.

FIGS. 13-16 illustrate various embodiments of the present invention of an optical transmission system using a nonlinear material.

### DETAILED DESCRIPTION OF THE INVENTION

The present invention is directed to optical transmitters using a nonlinear material, implemented as, but not limited to, a film, a bulk structure or a waveguide to compensate for or modify transmitter frequency chirping and improve signal transmission performance.

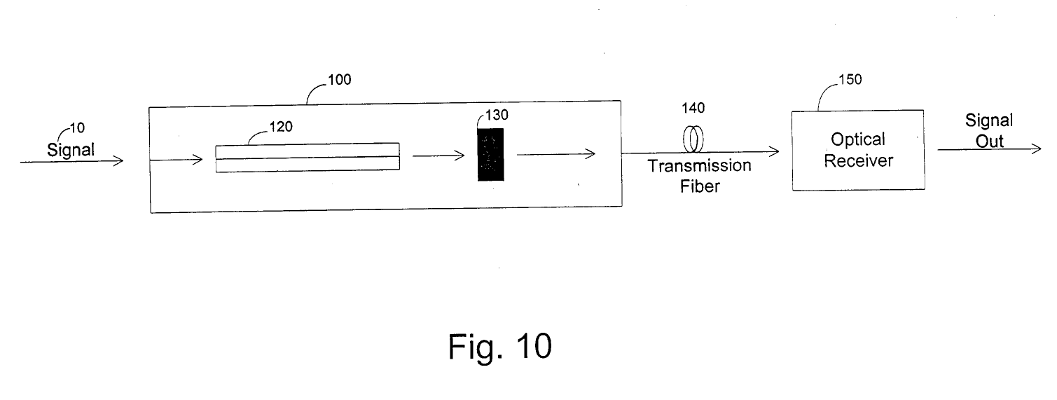

FIG. 9 is a logarithmic plot of an effective length profile versus nonlinear index coefficient graph. From experimentation using highly nonlinear dispersion shifted fiber (HNL-DSF), the required nonlinear phase shift γPL_{eff} for compensating the frequency chirping of a directly modulated laser is estimated around 2-3 radians. For a typical external modulator, the γPL_{eff} value is around 0.5 to 0.75 radians. Here, γ [W⁻¹m⁻¹] is the nonlinear coefficient, P [W] is the launched optical power into the nonlinear material, and L_{eff} [m] is the effective length of the nonlinear material.

Relationship between nonlinear index coefficient n2 and nonlinear coefficient γ is given by

$$γ = \frac{2 π}{λ} \frac{n 2}{{A}_{eff}} \qquad ( 1 )$$

where λ is the wavelength of the laser beam, and A_{eff} is the effective area of the beam.

By using mode field diameter (MFD), A_{eff} is given by

A_{eff}=π(MFD/2)² (2)

Relationship among power P, effective length L_{eff}, and nonlinear index coefficient n2 (after substituting the definitions of γ and A_{eff}) is

$${γPL}_{eff} = \frac{2 π}{λ} \frac{n 2}{{π ( MFD / 2 )}^{2}} \cdot P \cdot {L}_{eff} = \frac{8}{λ} \frac{n 2}{{MFD}^{2}} \cdot P \cdot {L}_{eff} \qquad ( 3 )$$

Since it is already known that required γPL_{eff} is around 2-3 radians (for directly modulated lasers), the relationship between n2 and L_{eff} is known. In FIG. 9, P=10 mW, λ=1550 nm, and γPL_{eff}=2.25.

The relationship between effective length (L_{eff}) and actual length L is given by equation (4):

$${L}_{eff} = \frac{1}{α} [ 1 - exp ( - α \cdot L ) ] \qquad ( 4 )$$

In equation (4), α is the material loss and is in dimensions of 1/m, α[m⁻¹]. From equation (3), it is clear that a larger n2 gives a shorter L_{eff} for a constant γPL value. Similarly, a smaller MFD gives a shorter L_{eff}, or a smaller MFD allows for smaller n2.

FIG. 9 illustrates the dependency of effective length of a nonlinear material (which has, at least, third order nonlinear susceptibility χ³) such as a fiber, a waveguide, a bulk structure, including a film, on the nonlinear index coefficient based on mode field diameters (“MFD”). Typically, the nonlinear index coefficient of a Chalcogenide nonlinear fiber is between 10⁻¹⁸ and 10⁻¹⁷ m²/Watt. This would translate into an effective length of approximately 1000 meters with a MFD of about 10 μm and even greater effective length with increasing MFD. Similarly, a Germanium doped Silicon (GcO₂-SiO₂) nonlinear fiber would require an effective length of approximately 10⁵ meters for an MFD of about 10 μm and even greater effective length with increasing MFD.

In contrast, the effective length versus nonlinear index coefficient profile of a nonlinear material such as a film or a bulk structure is shown in FIG. 9 by the area labeled “bulk.” A typical nonlinear index coefficient of a nonlinear film or a nonlinear bulk structure is about 10⁻¹⁰ m²/Watt, and with a MFD of about 10 μm, the effective length is reduced to about 10⁻⁵m. Typically, the thickness of a film is about (10 μm, and the thickness of a bulk structure is greater than 10 μm). A preferred thickness of the bulk structure is between 100 μm and 1 mm.

Similarly, the effective length versus nonlinear index coefficient profile of the nonlinear material such as a waveguide is shown in FIG. 9 by the area labeled “waveguide.” A typical nonlinear index coefficient of a nonlinear waveguide is between 10⁻¹² and 10⁻¹⁰ m²/Watt and with a MFD of about 10 μm, the effective length is reduced to about 10⁻³-10⁻⁵ m. Thus, usage of a nonlinear material such as a nonlinear film, a nonlinear bulk structure or a nonlinear waveguide to compensate for frequency chirping is desirable since with the reduced effective length characteristics of these nonlinear materials (film, bulk structure or waveguide), the size of the optical transmitter can be greatly reduced, as opposed to using a highly nonlinear fiber, without compromising performance.

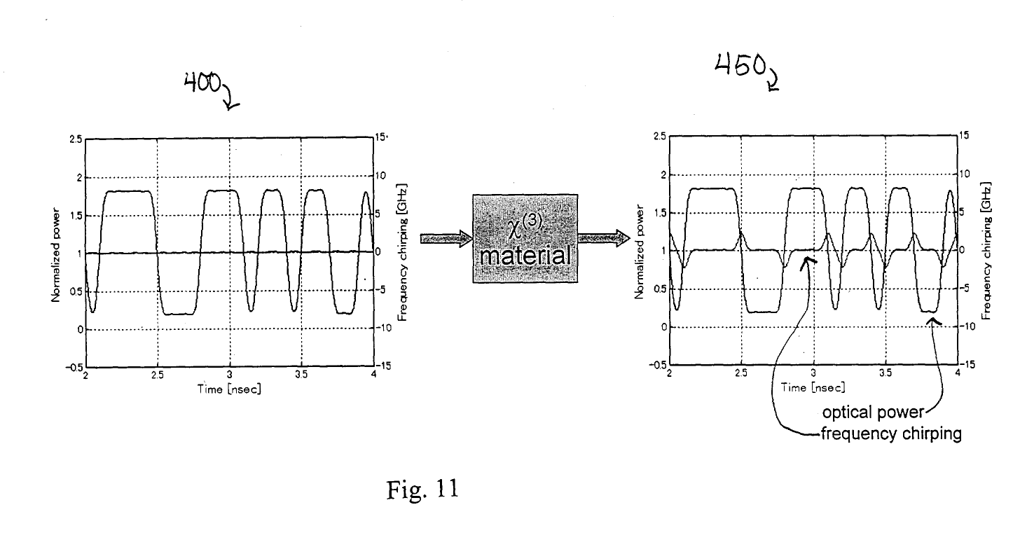

FIG. 10 is a block diagram of an embodiment of an optical transmission system in accordance with the present invention. In a first embodiment, the optical transmitter 100 comprises a laser driver/distributed feedback laser diode unit 120 and a nonlinear material 130. The nonlinearity characteristic of the nonlinear material 130 is desirable for compensating unwanted transmitter frequency chirping.

With the placement of the nonlinear material 130 at the output of the distributed feedback laser diode unit 120, the nonlinear material 130 introduces a negative frequency chirp versus the transmitted optical pulse power level to compensate the positive frequency chirping of the distributed feedback laser diode. In a preferred embodiment, the nonlinear material is a film with effective length of about 10⁻⁵ meters and a nonlinear index coefficient of about 10⁻¹⁰ m²/Watt. Although this preferred combination of effective length and nonlinear index coefficient of the film is mentioned, it will be appreciated that it is presented only as an example and the invention is not limited thereby.

The laser driver/diode unit 120 amplifies and/or reshapes and modulates the input signal 10. The modulated signal is then passed through the nonlinear material 130 before being output from the optical transmitter 100 to the transmission fiber 140 and finally to the optical receiver 150. Frequency chirping is a byproduct of the distributed feedback laser diode 120 which results in transmitter signal distortion. However, in the optical transmitter of the present invention, the nonlinear material 130 compensates for the frequency chirp generated by the laser driver/diode unit 120. As a result, a less distorted signal is passed through the transmission fiber 140 to the optical receiver 150.

In other preferred embodiments, the nonlinear material is a nonlinear bulk structure or a nonlinear waveguide. The effective length versus nonlinear index coefficient characteristics of a preferred nonlinear waveguide or nonlinear bulk structure are shown in FIG. 9. In the present example, the power input to the nonlinear material is set at 10 m Watt. As an example, a waveguide with a nonlinear index coefficient of between 10⁻¹² to 10⁻¹¹ m²/Watt and a MFD of 10 μm at an effective length of 10⁻³ meters may be used to implement the pre-chirping technique of the present invention. Similarly, a bulk structure with a nonlinear index coefficient of between 10⁻¹⁰ to 10⁻⁹ m²/Watt and a MFD of 10 μm at an effective length of 10⁻⁵ meters may be used in place of a nonlinear film with the same nonlinearity characteristics to achieve similar frequency chirping compensation.

With the use of the nonlinear material 130 (film, bulk structure or waveguide) having the above-described nonlinearity characteristics, one can expect similar improved transmission performance (i.e., less signal distortion) as with the use of a highly nonlinear fiber. The clear eye pattern, the bit error rates, the power penalty performances and binary pattern length dependencies are expected to be similar to those disclosed in the application filed with the United States Patent Office on Sep. 23, 2002, U.S. patent application Ser. No. 10/251,836 entitled An Optical Transmitter Using Highly Nonlinear Fiber and Method invented by Katsumi Uesaka.

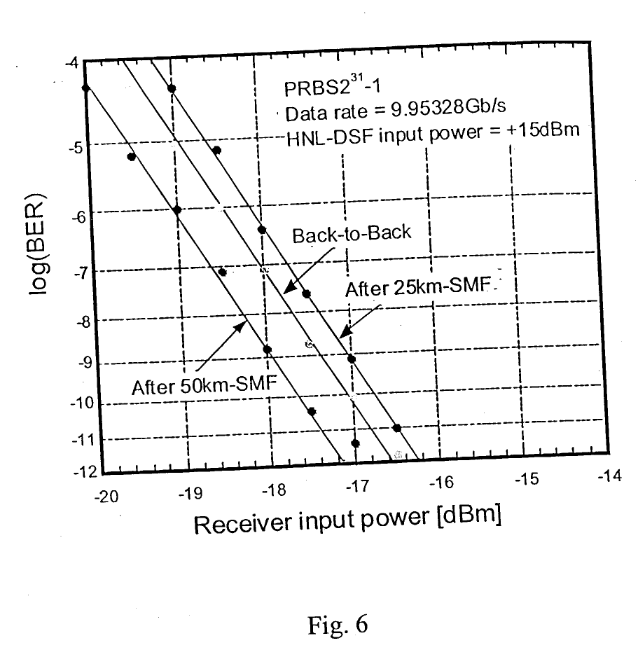

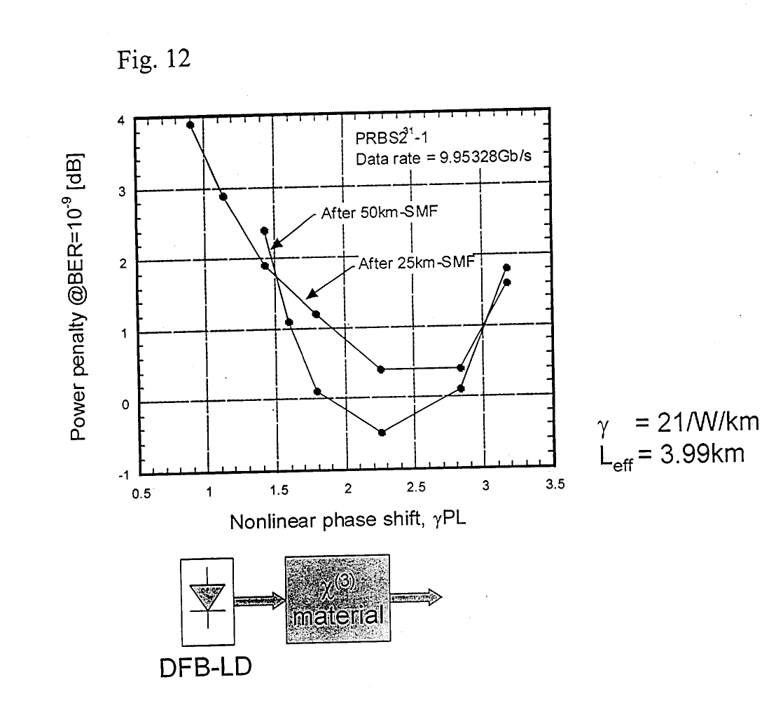

FIG. 11 is a simulated performance graph for the present invention shown in FIG. 10. FIG. 11 explains the frequency chirping induced by a nonlinear material. Suppose we input optical signal without frequency chirping into a nonlinear material, which is illustrated in the left side 400 of FIG. 11, the output optical signal from the nonlinear material includes negative chirp as illustrated in the right side 450 of FIG. 11. Since directly modulated laser has intrinsic positive chirp characteristics, this positive chirp can be compensated by the frequency chirp induced in the nonlinear material. (See also FIG. 5) It is said that for a long haul transmission, slightly negative chirping is preferred. Therefore, we can apply this scheme for external modulation system. In this case, zero-chirped external modulated signal can be pre-chirped adequately by a nonlinear material. In the present invention as shown in FIG. 10, the block 130 is the nonlinear material which can be implemented in its preferred embodiment with a film, a bulk structure or a waveguide with the nonlinearity characteristics discussed above.

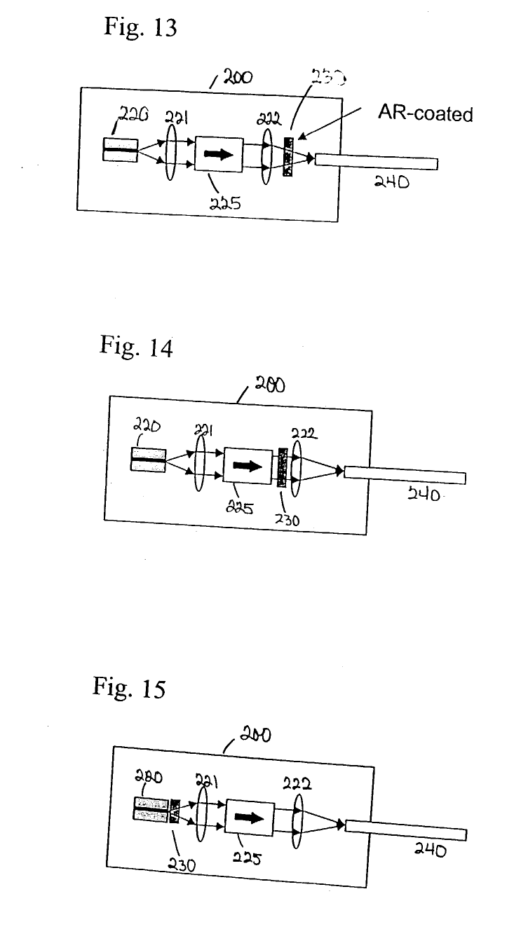

The power penalty characteristics of the present invention shown in FIG. 10 (which is tested in a laboratory setup that emulates the present invention under various transmission scenarios) is illustrated in FIG. 12. FIG. 12 illustrates the power penalty [dB] characteristics of the nonlinear material for two transmission fiber lengths (25 km single mode fiber and 50 km single mode fiber), at an operating point of 10⁻⁹ bit error rate, versus nonlinear phase shift, γPL. The 50 km SMF fiber length has a lower power penalty than the 25 km SMF fiber length near the optimum nonlinear phase shift 2.25 radians (at the input of the nonlinear material). Power penalty is referenced relative to the back-to-back link scenario. FIG. 12 also indicates the increased power penalty sensitivity for over pre-chirped signals versus under pre-chirped signals. To improve bit error rate performance, a forward error correction (FEC) technique (known to one of ordinary skill in the art) is combined with the pre-chirping technique of the present invention to correct transmitted signal errors. In one embodiment, the combination of forward error correction technique and the pre-chirping technique of the present invention improves communication performance. The combination of pre-chirping technique and forward error correction technique avoids the need for a booster amplifier which adds cost, complexity and/or bulk to the system.

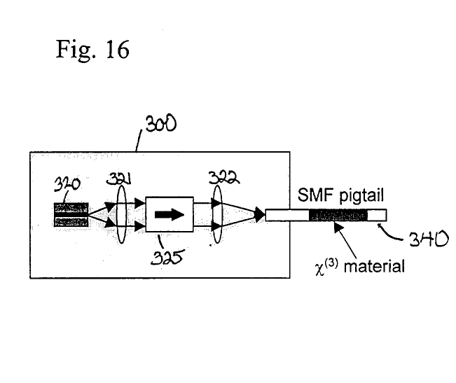

In FIGS. 13-16 other embodiments of the present invention are shown.

In FIGS. 13-15, the optical transmitter 200 comprises a laser driver/distributed feedback laser diode unit 220, two optical lenses 221, 222 for focusing an optical signal, an isolator 225 for compensating reflection and a nonlinear material 230 for chirp compensation. In FIG. 13, the output of the laser driver/distributed feedback laser diode unit 220 is coupled the optical lens 221 which is also coupled to isolator 225. The other end of the isolator is coupled to the another optical lens 222. The optical lens 222 is then coupled to the nonlinear material 230 before reaching the output of transmitter 200. In FIG. 14, the output of the laser driver/distributed feedback laser diode unit 220 is coupled to the optical lens 221 which is also coupled to isolator 225 at its other end. The isolator is then coupled to the nonlinear material 230. The nonlinear material 230 (at its other end) is coupled to the another optical lens 222 which is coupled to the output of transmitter 200. In FIG. 15, the output of the laser driver/distributed feedback laser diode unit 220 is coupled to the nonlinear material 230. The other end of the nonlinear material 230 is coupled to the optical lens 221. At one end, the isolator 225 is coupled to the optical lens 221. At its other end, the isolator 225 is coupled to another optical lens 222. Optical lens 222 is also coupled to the output of transmitter 200. In the embodiments shown in FIGS. 13-15, the output of the optical transmitter 200 is coupled to a single mode fiber 240 for transmission of an optical signal to another destination. In a preferred embodiment, the nonlinear material 230 is one of the following: a waveguide, a film or a bulk material with nonlinearity versus effective length characteristics (as shown in FIG. 9) to compensate unwanted frequency chirping. In one embodiment, the nonlinear material 230 is coated with an anti-reflection (“AR”) coating. As shown in FIGS. 13-15, the placement of the nonlinear material 230 may vary relative to the other components of the optical transmitter 200 as a design choice known to one skilled in the art.

In FIG. 16, the optical transmitter 300 comprises a laser driver/distributed feedback laser diode unit 320, two optical lenses 321, 322 for focusing an optical signal and an isolator 325 for compensating reflection. The output of the optical transmitter 300 is coupled to a single mode fiber 340 for transmission of an optical signal to another destination. The single mode fiber 340 includes a nonlinear material portion for compensating the frequency chirp from the laser driver/distributed feedback laser diode unit 320. In this embodiment, the pre-chirping technique is implemented through the single mode fiber which includes a nonlinear material portion.

Although preferred arrangements of an optical transmitter system utilizing a nonlinear material are shown in FIGS. 13-16, it should be noted that other arrangements (including additional units) are possible for achieving the desired signal performance and (other variations which are within the scope of the invention as defined in the claims) will be apparent to those skilled in the art.

What is claimed is:

1. An optical transmitter comprising:
an input for inputting a signal;
a laser diode for signal modulation;
a nonlinear material coupled to the laser diode, wherein the nonlinear material compensates for signal distortions caused by the laser diode; and
an output for outputting the signal.

2. The optical transmitter of claim 1 wherein the laser diode is a distributed feedback laser diode.

3. The optical transmitter of claim 2 further comprising a laser driver coupled to the laser diode for amplifying the signal.

4. The optical transmitter of claim 1 further comprising a first optical lens for focusing the signal, the first optical lens being coupled to the laser diode.

5. The optical transmitter of claim 4 further comprising an isolator, the isolator having a first end and a second end, the first end being coupled to the first optical lens.

6. The optical transmitter of claim 5 further comprising a second optical lens with a first side and a second side, the first side of the second optical lens being coupled to the second end of the isolator

7. The optical transmitter of claim 6 wherein the nonlinear material is coupled to the second side of the second optical lens.

8. The optical transmitter of claim 6 wherein the nonlinear material is coupled between the first side of the second optical lens and the second end of the isolator.

9. The optical transmitter of claim 6 wherein the first optical lens includes a first side and a second side and the nonlinear material is coupled between the first side of the first optical lens and the laser diode.

10. The optical transmitter of claim 1 wherein the nonlinear material is a nonlinear film.

11. The optical transmitter of claim 10 wherein the nonlinear film has a nonlinear index coefficient greater than 10⁻¹⁰ m²/Watt.

12. The optical transmitter of claim 10 wherein the nonlinear film has a nonlinear index coefficient of about 10⁻¹⁰ m²/Watt.

13. The optical transmitter of claim 10 wherein the nonlinear film has a nonlinear index coefficient of about 10⁻¹⁰ m²/Watt at a mode field diameter of 10 μm and an input power to the nonlinear film of 10 m Watt.

14. The optical transmitter of claim 10 wherein the nonlinear film has a nonlinear index coefficient greater than 10⁻¹⁰ m²/Watt at a mode field diameter of 100 μm and an input power to the nonlinear film of 10 m Watt.

15. The optical transmitter of claim 1 wherein the nonlinear material is a nonlinear bulk structure.

16. The optical transmitter of claim 15 wherein the nonlinear bulk structure has a nonlinear index coefficient greater than 10⁻¹⁰ m²/Watt.

17. The optical transmitter of claim 15 wherein the nonlinear bulk structure has a nonlinear index coefficient of about 10⁻¹⁰ m²/Watt.

18. The optical transmitter of claim 15 wherein the nonlinear bulk structure has a nonlinear index coefficient of about 10⁻¹⁰ m²/Watt at a mode field diameter of 10 μm and an input power to the nonlinear bulk structure of 10 m Watt.

19. The optical transmitter of claim 15 wherein the nonlinear bulk structure has a nonlinear index coefficient greater than 10⁻¹⁰ m²/Watt at a mode field diameter of 100 μm and an input power to the nonlinear bulk structure of 10 m Watt.

20. The optical transmitter of claim 1 wherein the nonlinear material is a nonlinear waveguide.

21. The optical transmitter of claim 20 wherein the nonlinear waveguide has a nonlinear index coefficient greater than 10⁻¹² m²/Watt.

22. The optical transmitter of claim 20 wherein the nonlinear waveguide has a nonlinear index coefficient between 10⁻¹² m²/Watt and 10⁻¹⁰ m²/Watt.

23. The optical transmitter of claim 20 wherein the nonlinear waveguide has a nonlinear index coefficient between 10⁻¹² m²/Watt and 10¹⁰ m²/Watt at a mode field diameter of 10 μm and an input power to the nonlinear waveguide of 10 m Watt.

24. The optical transmitter of claim 20 wherein the nonlinear waveguide has a nonlinear index coefficient greater than 10⁻¹⁰ m²/Watt at a mode field diameter of 100 μm and an input power to the nonlinear waveguide of 10 m Watt.

25. The optical transmitter of claim 1 wherein the nonlinear material is a nonlinear fiber.

26. The optical transmitter of claim 25 wherein the nonlinear fiber has a nonlinear index coefficient greater than 10⁻¹⁴ m²/Watt.

27. The optical transmitter of claim 25 wherein the nonlinear fiber has a nonlinear index coefficient of about 10⁻¹⁴ m²/Watt.

28. The optical transmitter of claim 25 wherein the nonlinear fiber has a nonlinear index coefficient of 10⁻⁴ m²/Watt at a mode field diameter of 10 μm and an input power to the nonlinear fiber of 10 m Watt.

29. The optical transmitter of claim 25 wherein the nonlinear fiber has a nonlinear index coefficient of about 10⁻¹⁴ m²/Watt at a mode field diameter of 100 μm and an input power to the nonlinear fiber of 10 m Watt.

30. An optical transmitter comprising:
a laser unit for signal amplification and/or signal modulation; and
a nonlinear material coupled to the laser unit, wherein the nonlinear material compensates for signal distortions caused by the laser unit.

31. The optical transmitter of claim 30 further comprising
at least one optical lens for focusing an input signal, the at least one optical lens being coupled to the laser unit; and
an isolator coupled to the at least one optical lens for compensating signal reflection.

32. An optical transmission system comprising:
an optical transmitter including an input for inputting a signal, a laser unit for amplifying the signal, and an output for outputting the signal; and
a single mode fiber coupled to the output wherein the single mode fiber comprises a nonlinear material for compensating transmitter signal distortions.

33. The optical transmitter of claim 32 wherein the nonlinear material is a nonlinear film.

34. The optical transmitter of claim 32 wherein the nonlinear material is a nonlinear bulk structure.

35. The optical transmitter of claim 32 wherein the nonlinear material 25 is a nonlinear waveguide.

36. The optical transmitter of claim 32 wherein the nonlinear material is a nonlinear fiber.

37. A method for transmitting a signal comprising:
generating a signal;
modulating the signal with a modulator; and
compensating distortion to the signal by passing the signal through a nonlinear material.

38. The method of claim 37 wherein the distortion is a frequency chirp.

39. The method of claim 37 wherein the nonlinear material has a nonlinear index coefficient of about 10⁻¹⁰ m²/Watt.

40. The method of claim 37 wherein the nonlinear material has a nonlinear index coefficient of about 10⁻¹² m²/Watt.

41. The method of claim 37 wherein the nonlinear material has a nonlinear index coefficient of about 10⁻¹⁴ m²/Watt.
